(19) United States
(12) Patent Application Publication
(10) Pub. No.: US 2011/0266713 A1
(43) Pub. Date: Nov. 3, 2011

(54) METHOD OF ENCAPSULATION OF A FLEXIBLE COMPONENT

(76) Inventors: Graeme Vincent, New South Wales (AU); Mark Berelowitz, New South Wales (AU); Milind Raje, New South Wales (AU)

(21) Appl. No.: 13/141,000

(22) PCT Filed: Dec. 18, 2009
(86) PCT No.: PCT/AU09/01661

§ 371 Date: Jul. 18, 2011

(30) Foreign Application Priority Data
Dec. 18, 2008 (AU) 2008906501

(51) Int. Cl. B29C 45/14

(52) U.S. Cl. 264/255

(57) ABSTRACT

A method of encapsulation of a flexible component having a preferred shape and dimensions including a void within the flexible component is disclosed. The method includes at least partially encapsulating the flexible component in a first mould using a curable material which shrinks in volume as it cures distorting the flexible component. The method includes an additional step of at least partially encapsulating the flexible component in a second mould using a curable material at a pressure so as to at least fill and expand unoccupied volume of the void such that the flexible component substantially conforms to the preferred shape and preferred dimensions of the flexible component. The flexible component may be of shape memory material. The method can be used to encapsulate medical devices which include a flexible component such as a coil/wire antenna such that the encapsulated medical device can be inserted into a human or animal body whilst achieving a preferred shape and configuration of the flexible component such as a coil antenna.

### CROSS-REFERENCE TO RELATED APPLICATIONS

This application is a National Stage Application of International Application No. PCT/AU2009/001661, filed Dec. 18, 2009, and claims the benefit of Australian Provisional Application No. 2008906501, filed Dec. 18, 2008. The contents of these applications are which is hereby incorporated by reference herein.

### BACKGROUND

1. Field of the Invention

The present invention relates to a method of encapsulating a flexible component. In a particular form, the invention relates to a method of moulding capable of encapsulating flexible components.

2. Related Art

Medical devices are commonly comprised of delicate mechanical and electrical components. As such, it is necessary to protect the medical device from surrounding influences which may place undue stress on these components and those influences may include but are not restricted to mechanical, temperature and chemical. Furthermore, it is also necessary to protect the recipient from the sharp edges of an implanted medical device and to limit bone growth over the medical device. The medical device is therefore often encapsulated in an outer cover to protect the medical device and the components therein as well as special purpose components external to the medical device. Medical devices and associated medical components as described herein are used as examples of the types of medical devices and components that need to be or can be encapsulated by a moulding process to ultimately protect them against their working environment or to protect, in the case of medical applications for the encapsulated component, a patient from any undesirable effects due to an unencapsulated medical device.

A method used to encapsulate medical device may include the step of moulding a cover over a medical device to produce a protected device. By way of an example, moulding using an injection moulding process includes the step of placing a medical device within a mould which is filled under pressure with a curable liquid (such as liquid silicone rubber) so as to completely or partially surround the medical device. The curable material cures while located in the space or volume between the medical device and the mould. Once the liquid has cured sufficiently, the over moulded medical device can be removed. A second moulding process is sometimes required to over mould the first result of the moulding step, to provide and additional layer of protective material or to mould over parts or portions of the medical device not encapsulated previously.

Injection moulding however can unduly affect the appearance and/or function of delicate medical and other devices and/or flexible components. In particular, the moulding process involves heating of the mould while encapsulated with the injected liquid to set the liquid, and during the further setting process shrinkage of the curable liquid occurs.

The curable liquid is commonly silicone, and the shrinkage of the liquid around the medical device within the mould can be many percentages of the total volume of the liquid before being cured. The moulding process and in particular the shrinkage of the liquid around the medical device, can therefore adversely affect a flexible component which may be part of or external to the medical device. Thus flexible components can be distorted from their preferred desired shape by the forces associated with the shrinkage of the encapsulating material. For example, for wires formed into a planar coil located external of a medical device housing used for example as an antenna, may distort when the silicone formed about the coil shrinks during the cooling process by a different amount than any contraction of the coil dimensions and may subsequently create distortion due to residual stresses inwards of the coil. The coil may be deformed so as to change the physical and ultimately the electrical performance of the coil. If the residual stresses are higher than the structural integrity of the coil, the coil geometry may be substantially changed and the coil may warp and thus distort the radiation pattern of the coil or detune the coil. Furthermore, distortion of the medical device or a flexible component of a medical device may occur due to additional factors such as non-uniform shrinkage of the moulded material, different coefficients of expansion within the moulded material and heating effects.

There is therefore a need for a method of moulding capable of encapsulating flexible components without inducing distortion of, or stress on, the flexible component in its moulded state. Such a method may also offer improved efficiency and simplicity for moulding of medical devices that include or are flexible compared to existing methods.

The present application claims priority from Australian Provisional Patent Application No. 2008906501 titled “A method of encapsulation of a flexible component” and filed on 18 Dec. 2008. The entire content of this application is hereby incorporated by reference.

### SUMMARY

In a first aspect, the present invention accordingly provides a method of encapsulation of a flexible component, the flexible component having a preferred shape and preferred dimensions including a void within the flexible component, the steps of the method including:

at least partially encapsulating the flexible component in a first mould which partially occupies the void, using a curable material which shrinks in volume as it cures wherein the void is partially occupied by cured material and the flexible component is distorted once the encapsulating material has cured;

at least partially encapsulating the flexible component in a second mould using a curable material at a pressure so as to at least fill and expand unoccupied volume of the void such that the flexible component substantially conforms to the preferred shape and preferred dimensions of the flexible component.

The inner void may include placing an insert of preformed material compatible with the curable material within the void before the flexible component is placed in the first mould. The method may include the further step wherein the insert of preformed material is removed and the flexible component is returned to the first mould using curable material to fill the unoccupied volume previously filled by the insert.

Alternatively, the method may include the further step wherein the insert of preformed material is removed from the void before the flexible component is placed in the second mould.

Alternatively, the method of encapsulation of a flexible component may include the insert of preformed material compatible with the curable material being placed within the void before the flexible component is placed in the second mould.

In a second aspect, the present invention accordingly provides a method of encapsulation of a flexible component of shape memory material, the flexible component having a preferred memorized shape and preferred memorized dimensions including a void within the flexible component, the steps of the method including:

placing the flexible component in an expanded shape in a first mould which partially occupies the void;

at least partially encapsulating the flexible component in the first mould, using a curable material which shrinks in volume as it cures wherein the void is partially occupied by cured material and the memorized shape and preferred memorized dimensions of the flexible component are substantially restored once the encapsulating material has cured.

The method may include the further step wherein the at least partially encapsulated flexible component is placed in a second mould and further encapsulated using a curable material at a pressure so as to once cured not substantially distort the encapsulated flexible component.

An insert of preformed material compatible with the curable material may be placed within the void before the flexible component is placed in the first mould. The insert of preformed material may be removed the void before the flexible component is placed in the second mould.

Alternatively, the method of encapsulation of a flexible component may include the insert of preformed material compatible with the curable material being placed within the void before the flexible component is placed in the second mould.

The portion of the first mould adjacent to the flexible component may be at a substantially higher temperature than some or all of the portions of the mould not adjacent to the flexible component during curing of the curable material so as to shorten the curing period in the encapsulated volume adjacent the flexible component.

The curable material may be injected into the second mould at an injection pressure higher than that used for the first mould to compress cured curable material.

The flexible component may be part of or coupled to a medical device and wherein both the flexible component and medical device are encapsulated by the curable material in a respective mould.

The second mould may be adapted to provide at least one further void adjacent to the flexible component not within the void within the flexible component, to be filled by curable material such that the associated cured material creates an expansion pressure on the formed flexible component when the flexible component is placed in the mould.

In a third aspect, the present invention accordingly provides a method of encapsulation of a flexible component, the flexible component having a preferred shape and preferred dimensions including a void within the flexible component, the steps of the method including:

at least partially encapsulating the flexible component in a first mould which partially occupies the void, using a curable material which shrinks in volume as it cures wherein the void is partially occupied by cured material and the flexible component is distorted once the encapsulating material has cured;

using an insert of preformed material compatible with the curable material so as to at least fill and expand unoccupied volume of the void such that the flexible component substantially conforms to the preferred shape and preferred dimensions of the flexible component.

The at least partially encapsulated flexible component may be further encapsulated so as to at least encapsulate the insert.

In any of the aspects, the flexible component may be or may be part of a medical device.

Although the foregoing invention has been described in some detail for purposes of clarity of understanding, it will be apparent that certain changes and modifications may be practiced within the scope of the appended claims. It should be noted that there are many alternative ways of implementing both the process and apparatus of the present invention. Accordingly, the present embodiments are to be considered as illustrative and not restrictive, and the invention is not to be limited to the details given herein, but may be modified within the scope and equivalents of the appended claims.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

The reference to any prior art in this specification is not, and should not be taken as, an acknowledgment or any form of suggestion that such prior art forms part of the common general knowledge.

### BRIEF DESCRIPTION OF THE DRAWINGS

An illustrative embodiment of the present invention will be discussed with reference to the accompanying drawings wherein:

FIG. 1 is a perspective view of a medical device having a flexible component;

FIG. 2 is a perspective view of a distorted flexible component associated with a medical device;

FIG. 3A is a perspective view of an embodiment of a non-distorted encapsulated flexible component of a medical device;

FIG. 3B is a side view of the embodiment of a non-distorted encapsulated flexible component of a medical device illustrated in FIG. 3A;

FIG. 4 is a perspective view of a removable insert used within the flexible component of FIG. 1;

FIG. 5 is a perspective view of the bottom half of a first mould used to seat the medical device of FIG. 1 before encapsulation;

FIG. 6 is a perspective view of the top half of the a mould used to seat the medical device of FIG. 1 before encapsulation;

FIG. 7 is a perspective view of the encapsulated medical device of FIG. 1 having the removable insert within the flexible component after being removed from the first mould. For illustrative purposes the encapsulated medical device is shown as flat;

FIG. 8 is a perspective view of the encapsulated medical device of FIG. 7 wherein the encapsulated medical device has been removed from the first mould for the second time. The removable insert was removed from the flexible component and the unoccupied volume previously filled by the insert filled during the second placement and moulding in the first mould. For illustrative purposes encapsulated medical device is shown as flat;

FIG. 9 is a perspective view of the bottom half of the second mould used to seat the medical device of FIG. 1 before further encapsulation;

FIG. 10 is a perspective view of the top half of the second mould used to seat the medical device of FIG. 1 before further encapsulation of an encapsulated medical device;

FIG. 11 is a top view of the medical device of FIG. 8 encapsulated by encapsulating the flexible component in the second mould using curable material;

FIG. 12 is a partial side view of an embodiment of a portion of a flexible component partially encapsulated by a further moulding process;

FIG. 13 is a perspective view of an embodiment of a medical device having a flexible component encapsulated in the second mould using curable material. For illustrative purposes encapsulated medical device is shown as flat;

FIG. 14A is a perspective view of an embodiment of a flexible component of a medical device having an elastomeric material insert;

FIG. 14B is a perspective view of the embodiment of a medical device having a flexible component illustrated in FIG. 14A encapsulated by a moulding process. For illustrative purposes encapsulated medical device is shown as flat;

FIG. 15 is a perspective view of the bottom half of an embodiment of a mould for forming an annular moat in the void of the flexible component; and

FIG. 16 is a perspective view of an embodiment of a flexible component of a medical device having an annular moat after the flexible component is placed in the mould of

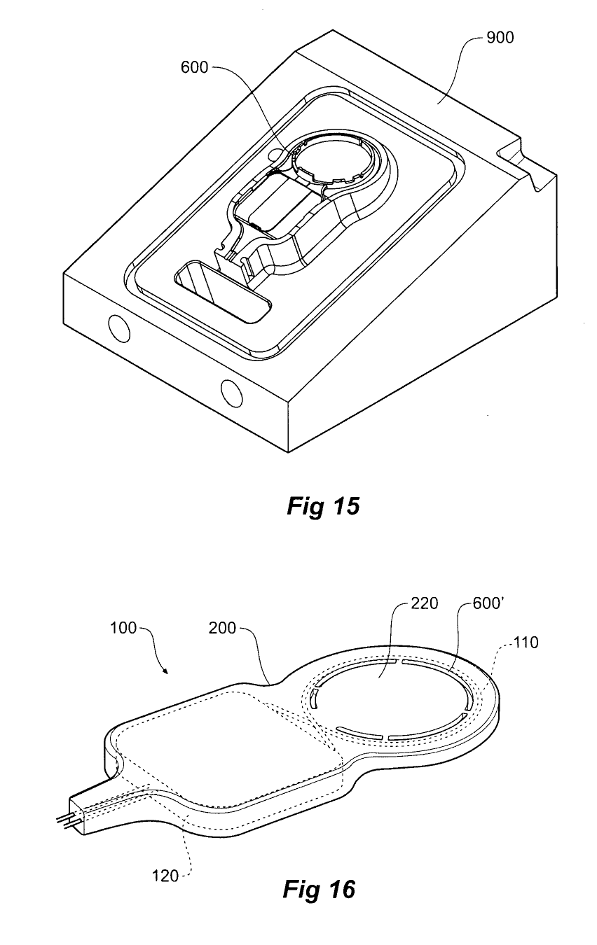

FIG. 15. For illustrative purposes encapsulated medical device is shown as flat;

In the following description, like reference characters designate like or corresponding parts through out the drawings.

### DETAILED DESCRIPTION

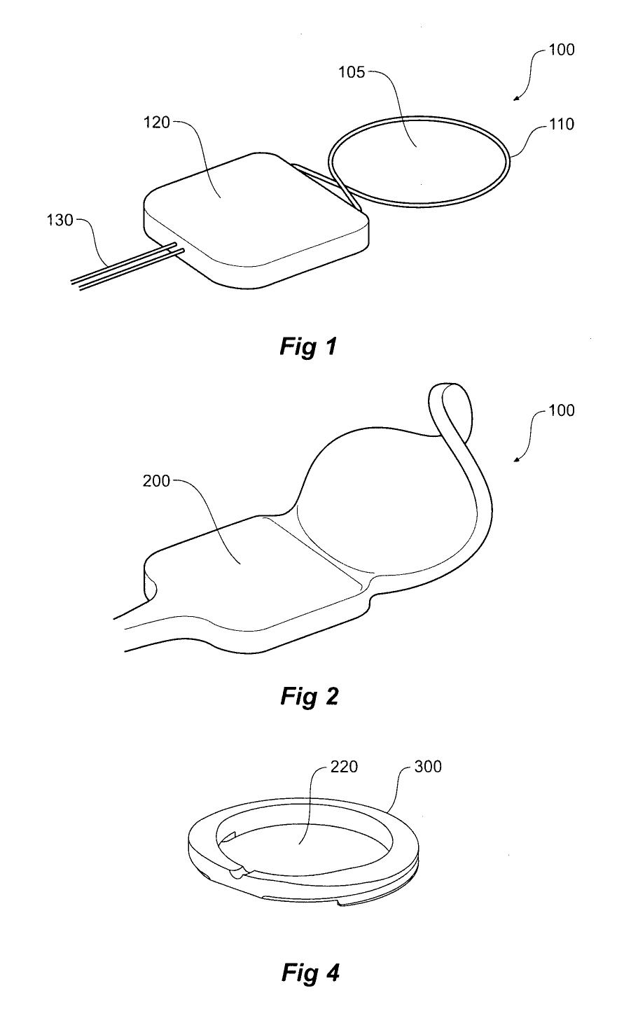

Referring now to FIG. 1, there is shown an illustration of a medical device 100. In this embodiment the medical device 100 is a medical implant comprising a stimulator housing 120, flexible coil 110 and two electrode leads 130. The stimulator housing 120 includes a titanium chassis housing electronic components which perform a multitude of functions including in this particular application, receiving signals from and generating signals for the flexible coil 110 which is an antenna, and processing the received signals so as to generate signals for connecting the two electrode leads 130. Such an arrangement is used in cochlea implant systems and such a device is implanted in the skull of a recipient patient.

The flexible coil 110 consists of coiled insulated platinum wire having a void 105 encompassed by the wire which forms the coil 110. The shape and dimensions of the flexible component depicted is but one of a plurality of shapes that could be used with medical devices. In this embodiment of a flexible component, the wire is thin compared to the stimulator housing 120 and in this embodiment, 0.9 mm diameter, and is flexible so that a small force can change the shape of the wire coil 110.

In order to protect both the medical device 100 and patient, the implanted medical device is commonly encapsulated in biocompatible silicone.

Traditionally encapsulation is performed using transfer moulding technology using liquid silicone rubber. The medical device 100 is placed within a mould, filled with liquid silicone rubber and heat cured. Once the silicone is sufficiently cured, the mould is opened and the over-moulded medical device 100 is removed. The problem with this method of encapsulation when used with a medical device which includes a portion of which is flexible such as that described above, is that the inherent shrinkage of liquid silicone rubber when curing distorts the flexible portion. Since the shrinkage is approximately 2.5%, a flexible coil 110 encapsulated using this technique may undergo distortion (as illustrated in FIG. 2). The term distorted when referring to the flexible component such as a coil may encompass shrinking, contraction, expansion, twisting or any other alteration to not only the original shape but also any preferred shape and/or dimensions of the flexible component.

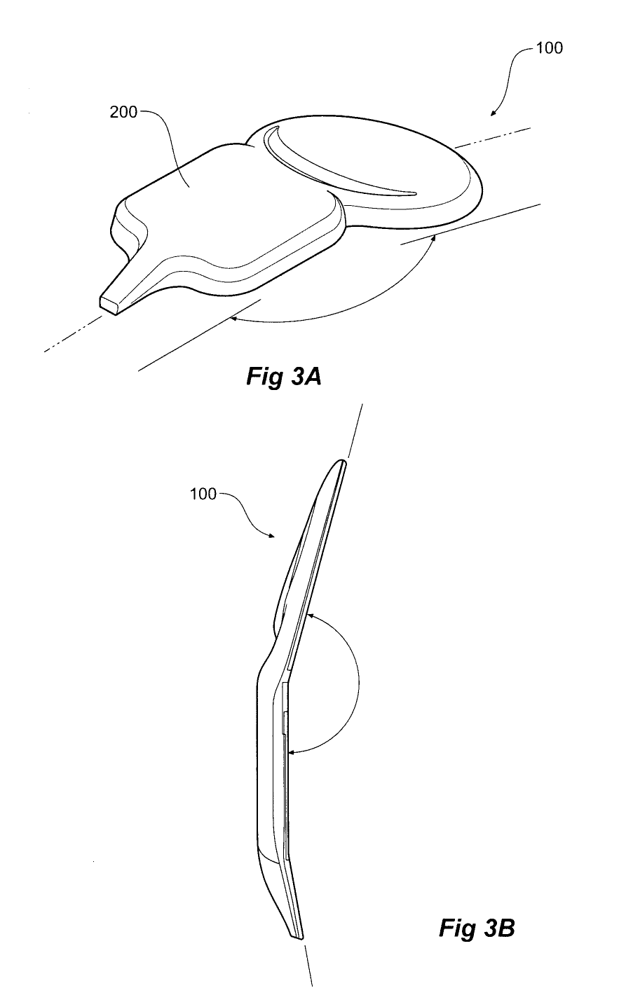

In another aspect, a second mould is sometimes required to mould over the first encapsulation. Such distortion may also occur if the coil 110 alone is encapsulated and other flexible components or elements are similarly affected. It is therefore preferable that an encapsulated coil does not result in distortion of the flexible coil 110. Instead the moulding should allow the preferred shape and dimensions of the coil as illustrated in FIGS. 3A and 3B to be created. Both an unencapsulated and an encapsulated medical device may be shaped to suit the application for which it is to be used. Consequently, a medical device may be contoured in one, two or three dimensions and therefore after encapsulation, the encapsulated medical device must also follow the same contour. In the example illustrated in FIGS. 3A and 3B, the encapsulated medical device is contoured in three dimensions to follow the curvature of the human skull.

In embodiments of the invention, the mould assembly may hold one or more components. The mould assembly may be substantially shaped to match the shape of the component to be encapsulated. A second mould assembly which has oversized outer dimensions relative to the then encapsulated component may also be used. The mould assembly is filled with an elastomeric material such as but not limited to liquid silicone rubber. The elastomeric material is biocompatible if the process is used on human or animal implantable components.

The mould assembly could also however be filled with a combination elastomeric and non-elastomeric materials for increased structural strength and flexibility. Such a combination may be two polymers such as silicone rubber and polyurethane. The mould assembly may be two open moulds opposed to each other and whereby the medical device sits within the bottom mould, the second mould forming a lid. The component may or may not be fully encapsulated by the elastomeric materials. The component may be a single unit.

In each of the embodiments of the invention described herein, the medical device 100 is represented by a medical implant as shown in FIG. 1 comprising a stimulator housing 120, flexible coil 110 and two electrode leads 130. The type of medical device to be moulded according to the methods disclosed is however not limited to that described herein. For example, the medical device may include a flexible component of any suitable shape wherein the flexible component has at least a void space within its physical bounds wherein the void is not necessarily a through hole within the component, and can also encompass a recess within the physical bounds of the flexible component.

For any of the embodiments of the invention described herein, the medical device or parts thereof may have been prior moulded before being further encapsulated according to those embodiments.

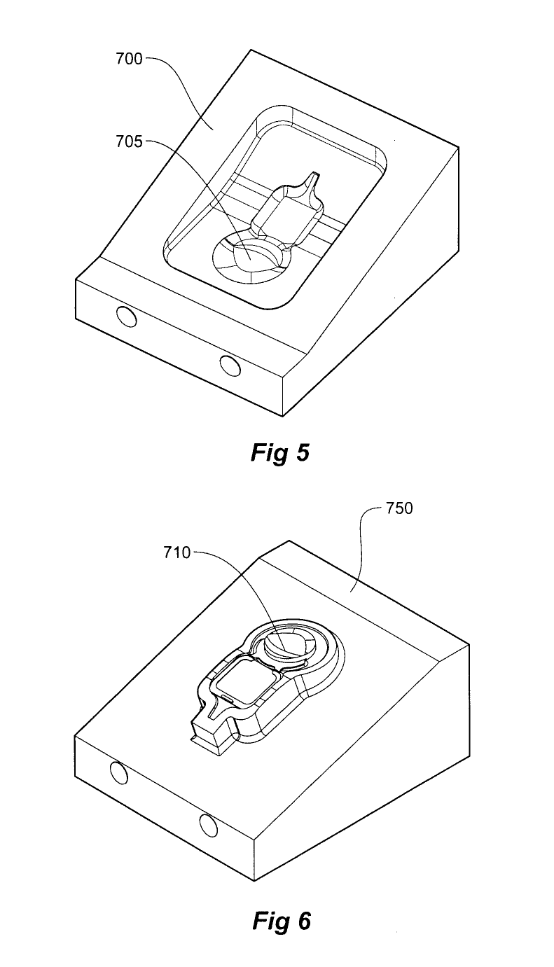

In one aspect of the invention (FIGS. 5-11), the medical device 100 is encapsulated by means of a three-stage encapsulation process. However, lesser and greater encapsulation stages are useable for this and other medical devices and components.

In a first-stage of the three-stage encapsulation process, the void region 105 located within the flexible coil 110 of a medical device 100 is loaded with a removable insert 300 (FIG. 4). The insert 300 is substantially sized to abut the internal diameter of the coil 110 and not place any undue outward pressure onto the flexible wire of the coil and hold the coil in a centralised position with respect to itself and if required the medical device 100 when enclosed in the mould die during a first stage encapsulation according to any of the embodiments. The medical device 100 together with the insert 300 is loaded onto one of the open mould dies 700, 750 (FIGS. 5 and 6). The mould dies 700, 750 are shaped to enclose the outer dimensions of the medical device 100 when fitted together. The mould die 750 is shaped in part to extend into and at least partially occupy the void 220 inside the removable insert 300 and together at least partially occupy the void 105 of the flexible coil 110.

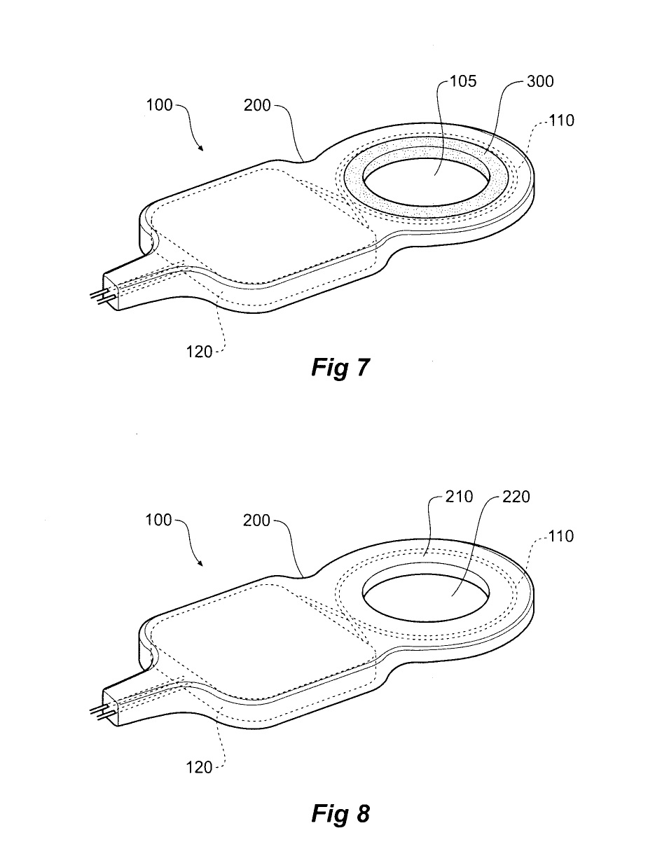

The loaded medical device is thus enclosed within the two mould dies 700, 750 to create an enclosed environment and a single opening services the feed for insertion of liquefied elastomeric material 200. The distribution of the liquefied elastomeric material can be by gravitation (flow moulding) or under pressure (injection moulding). The medical device 100 is thus at least partially encapsulated by the elastomeric material 200, in this case liquid silicone rubber, and heat cured. Silicone therefore at least partially encapsulates the medical device 100 including the flexible coil 110. The void region 105 of the flexible coil 110, including the region defined by the insert 300 is not completely filled with the elastomeric material 200 (FIG. 7) as the mould partially occupies the void region 105 as would be the case in view of the shaped regions 705 and 710 of FIGS. 5 and 6, respectively.

Moulding is preferably performed at a low injection pressure such as but not limited to approximately 40 bar. Such pressure may prevent indentation of the medical device by the injection pressure. In addition, the presence of the insert 300 within the void region 105 holds the wire coil 110 in position preventing deformation during the injection and curing of the elastomeric material 200. The insert 300 helps to minimise distortion of the wire coil 110 by withstanding the pressure placed on the coil 110 by the elastomeric material 200 as it cure which would otherwise push the coil 110 towards the insert 300. Once the elastomeric material 200 is sufficiently cured, the mould dies 700, 750 are opened and the at least partially encapsulated medical device 100 is removed.

It will be noted in the moulds depicted in FIGS. 5 and 6 that the general plane of the stimulator housing 120 in the mould is at an angle to the general plane of the flexible coil 110. This relative configuration shapes the final encapsulated medical device to the same contour of the human skull and will result in a shape depicted in FIGS. 3A and 3B.

After the first-stage of encapsulation, the partially encapsulated medical device 100 is removed from the mould dies 700, 750 and the insert 300 removed from its position in the void region 105 of the wire coil 110. The partially encapsulated medical device 100 is returned to the same mould dies 700, 750 used in the first-stage of encapsulation. The medical device 100 is moulded with the elastomeric material 210, in this case silicone rubber and heat cured such that the volume previously occupied by the insert 300 is filled with the elastomeric material 210 resulting in the encapsulated medical device depicted in FIG. 8.

Moulding in this second stage of the process is preferably performed at the same injection pressure used for the first partial encapsulation of the medical device (approximately 40 bar). Once the elastomeric material is sufficiently cured, the mould is opened and the encapsulated medical device 100 is removed. The medical device 100 after this stage may still only be partially encapsulated by the elastomeric material 210. A void region 220 remains within the wire coil 110.

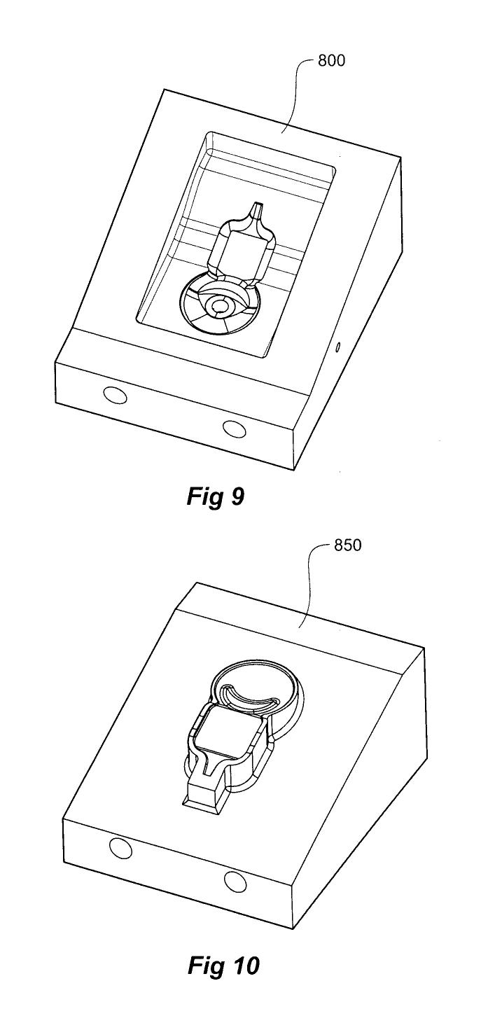

In the third stage of the encapsulation process described in this embodiment, the at least partially encapsulated medical device 100 is loaded onto a second set of mould dies 800, 850 (FIGS. 9 and 10). The encapsulated medical device 100 is further moulded using an elastomeric material to at least fill any volume of the medical device 100, not previously filled with the elastomeric material 220 dependant on the shape of the mould. Filling all unoccupied volumes of the encapsulated medical device 100, in particular the remaining void region 220 within the wire coil 110 provides an implantable medical device. Alternatively, a removable insert (not shown) may be placed into an unoccupied volume such as the remaining void region 220 of the encapsulated or partially encapsulated flexible component left after removal of the flexible component from the first mould. The removable insert may thus be partially or fully encapsulated within the medical device. Removal of the removable insert would leave a further void in the encapsulated flexible component.

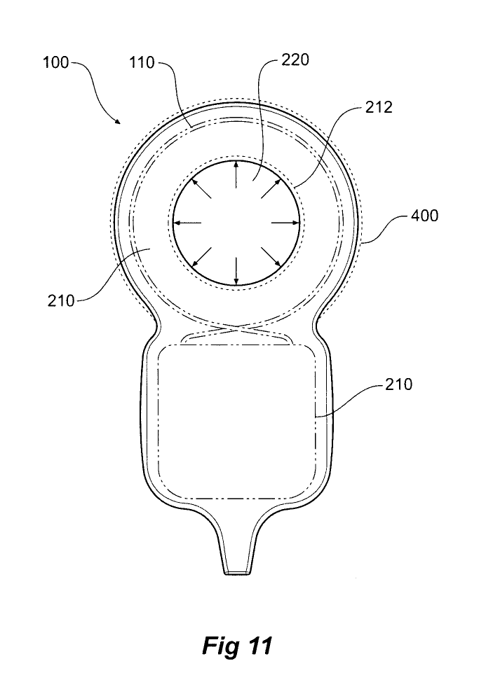

The encapsulation process using the second mould is performed at a pressure greater than the previous two stages such as but not limited to 80 bar. Higher pressures can be used in this stage since the flexible and somewhat more flexible components of the medical device are already at least partially encapsulated and substantially protected from the deformation effects of the further moulding process. The higher pressure radially expands the previously moulded elastomeric material around the coil 110. As such, the pressure stresses the encapsulated coil outwards radially against the resistance of the coil to radial expansion. Referring to FIG. 11, the expanding elastomeric material is able to swell due to an expansion void around the perimeter 400 of the flexible coil 110 since the cavity of the second mould is oversized around the flexible coil 110 (slightly larger than the cavity of the first mould). The positive pressure stresses the moulding radially outwards as the boundary 212 between the third moulding and the previous first and second moulding 210 shifts with resultant internal compressive stresses. As the third-stage encapsulation returns to room temperature, the internal stresses on the encapsulated flexible coil 110 are reduced as the newly moulded elastomeric material shrinks as it cures primarily as its temperature drops during cooling.

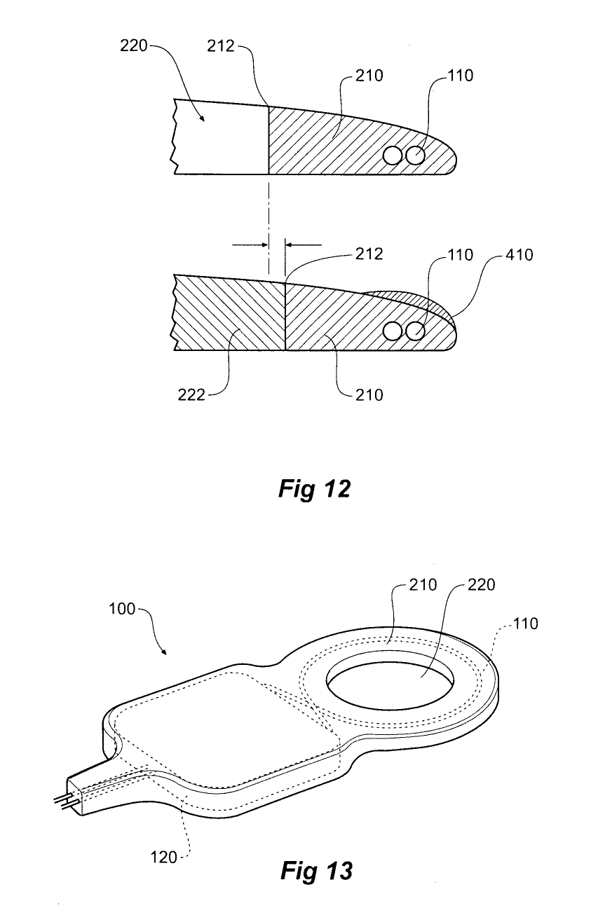

In an alternate to having the expansion void around the perimeter 400 of the flexible coil 110 formed in the second mould, the encapsulated flexible component may be shaped to allow a region of the encapsulated flexible component to itself be expanded during the second moulding step. As depicted in FIG. 12 the boundary 212 is moved outwards relative to the internal void of the flexible component and this is possible because of the provision or the expansion void or the region described above. Thus there is defined a region into which the encapsulated component itself can move while the elastomeric material is over moulded into the void within the flexible component.

The encapsulation process using this first embodiment is thus completed substantially reducing any residual stresses on the moulded silicone which encapsulates the flexible coil 110 and the encapsulated flexible coil 110 is thus substantially unaffected by the moulding process and thus achieves a preferred size, shape and orientation in a manner that allows it to perform as required once the medical device is implanted.

The three-stage encapsulation process may be reduced to a two-stage process by removing the need to use a removable insert during the first encapsulation process. The encapsulation process uses two of the aforementioned stages of the three-stage encapsulation process. The two-stage encapsulation is achieved by loading a medical device 100 is onto the first mould dies 700, 750. The mould die 750 is shaped to extend into the void inside the flexible coil 110 that is to at least partially occupy the void 105. The loaded medical device is thus enclosed within the two mould dies 700, 750 to create an enclosed environment and a single opening services the feed for insertion of liquefied elastomeric material 200.

The medical device 100 including the flexible coil 110 is thus at least partially encapsulated by the elastomeric material 200, the void region 105 not completely filled with the elastomeric material 200 since the mould partially occupies the void region 105 (shaped regions 705 and 710 of FIGS. 5 and 6, respectively).

The at least partially encapsulated medical device 100 is loaded onto the second set of mould dies 800, 850 (FIGS. 9 and 10). The encapsulation process described above is performed at a pressure greater than that of the encapsulation using the first mould. The higher pressure compresses the previously moulded elastomeric material around the medical device. The encapsulated medical device 100 is further moulded using an elastomeric material to at least fill any volume of the medical device 100, not previously filled with the elastomeric material 220 dependant on the shape of the mould. Filling all unoccupied volumes of the encapsulated medical device 100, in particular the remaining void region 220 within the wire coil 110 provides an implantable medical device. Further void space in the mould may be located adjacent the medical device 100. The flexible component 110 of the medical device 100 is therefore preferably unaffected by the moulding process and thus remains in the position set by the mould dies.

Alternatively, there is another two-stage process eliminating the need to return the encapsulated flexible component to the first mould after removing the removable insert from the encapsulated flexible component. The encapsulation process uses two of the aforementioned stages of the three-stage encapsulation process. In this embodiment, the void region 105 located within the flexible coil 110 of a medical device 100 is loaded with a removable insert 300 (FIG. 4). The insert 300 is substantially sized to abut the internal diameter of the coil 110 and not place any undue outward pressure onto the flexible wire of the coil and hold the coil in a centralised position when the medical device 100 is enclosed in the mould dies during encapsulation. The medical device 100 together with the insert 300 is loaded onto one of the open mould dies 700, 750 (FIGS. 5 and 6). The mould dies 700, 750 are shaped to enclose the outer dimensions of the medical device 100 when fitted together. The mould die 750 is shaped in part to extend into and at least partially occupy the void 220 inside the removable insert 300 and together at least partially occupy the void 105 of the flexible coil 110.

The loaded medical device is thus enclosed within the two mould dies 700, 750 to create an enclosed environment and a single opening services the feed for insertion of liquefied elastomeric material 200. The medical device 100 is thus at least partially encapsulated by the elastomeric material 200, in this case liquid silicone rubber and heat cured. Silicone therefore at least partially encapsulates the medical device 100 including the flexible coil 110. The void region 105 of the flexible coil 110, including the region defined by the insert 300 is not completely filled with the elastomeric material 200 (FIG. 7) as the mould partially occupies the void region 105 as would be the case in view of the shaped regions 705 and 710 of FIGS. 5 and 6, respectively.

Moulding is preferably performed at a low injection pressure such as but not limited to approximately 40 bar. Such pressure may prevent indentation of the medical device by the injection pressure. In addition, the presence of the insert 300 within the void region 105 holds the wire coil 110 in position preventing deformation during the injection and curing of the elastomeric material 200. The insert 300 helps to minimise distortion of the wire coil 110 by withstanding the pressure placed on the coil 110 by the elastomeric material 200 as it cure which would otherwise push the coil 110 towards the insert 300. Once the elastomeric material 200 is sufficiently cured, the mould dies 700, 750 are opened, the insert 300 removed and the at least partially encapsulated medical device 100 is removed.

The at least partially encapsulated medical device 100 is loaded onto the second set of mould dies 800, 850 (FIGS. 9 and 10). The encapsulation process is performed at a pressure greater than that of the encapsulation using the first mould. The higher pressure compresses the previously moulded elastomeric material around the medical device. The encapsulated medical device 100 is further moulded using an elastomeric material to at least fill any volume of the medical device 100, not previously filled with the elastomeric material 220 dependant on the shape of the mould. Filling all unoccupied volumes of the encapsulated medical device 100, in particular the remaining void region 220 within the wire coil 110 provides an implantable medical device.

In a variation of the above two stage process, the insert 300 within the void region 105 is retained in the partially encapsulated medical device 100 after removal from the first mould. The partially encapsulated medical device 100 including the insert 300 is therefore loaded onto the second set of mould dies 800, 850 (FIGS. 9 and 10) and encapsulation performed as above. The encapsulated medical device 100 is further moulded using an elastomeric material to at least fill any volume of the medical device 100, not previously filled with the elastomeric material 220 dependant on the shape of the mould and completely encapsulates the insert 300 to provide an implantable medical device.

In yet a further variation of the above two stage process, an insert of preformed material may be placed within the void region 220 remaining after the partially encapsulated flexible component is removed from the first mould. As such, the insert may be used to define a further void region after encapsulation of the medical device in the second mould or the insert may be encapsulated with the medical device.

Although not clearly depicted, the flexible coil is encapsulated to not only provide a preferred circular shape in plan view, but to also have a slight concave shape which further assists conformance of that part of the medical device when implanted in and against the skull of a recipient patient.

In a variation applicable to one or more of the moulding/encapsulation steps, it is possible to provide expansion voids about the flexible component 110 of the medical device 100 which enables the curable elastomeric material used to encapsulate the flexible component 110 to be forced into the void region 220 during subsequent encapsulation, resulting in reduced and in some cases almost no residual stresses to remain in the encapsulated flexible component 110. The advantage of such an arrangement is not limited to a three stage encapsulation process and may be used in moulding processes having one or more stage moulding steps.

An embodiment of the use of expansion voids, in another aspect of the invention, the second mould (not shown) has further expansion void spaces located adjacent the medical device 100 but not within the void 220 within the flexible component 110. The expansion voids in the second mould are provided by cavities in the mould adjacent to the flexible component, when the flexible component is seated in the mould. In each stage of a three stage moulding process, the flexible component 110 of medical device 100 is encapsulated in an elastomeric material 210 such as silicone rubber and heat cured. Later encapsulation stages are performed at an injection pressure of approximately 80 bar, a pressure higher than prior encapsulation stages. The positive pressure effected upon the medical device 100 by the higher pressure injection process produce a radial expansion pressure on the cured elastomeric material 210 at least partially encapsulating the flexible component 110 after the medical implant 100 is removed from the first mould. As such, the elastomeric material 210 is forced into the expansion void space 410 (FIG. 12). The positive pressure stresses the moulding radially outwards as the boundary 212 between the third moulding 222 and the previous first and second moulding 210 shifts with resultant internal compressive stresses.

The encapsulation process is thus completed, substantially reducing any residual stresses on the encapsulated flexible component 110 of medical device 100 thus their relative positions, orientation and preferred shape and dimensions set by the mould dies maintaining the medical devices' other physical and hence electrical characteristics. At any stage, the medical device 100 may be only partially encapsulated by the elastomeric material 210.

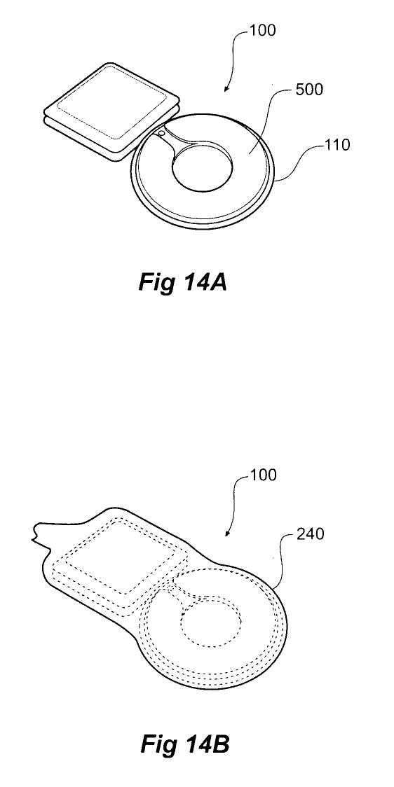

In yet a further alternate embodiment, the medical device 100 in the example of an medical device having a flexible coil 110 encapsulated by an elastomeric material 200, the flexible coil 110 comprises a previously created elastomeric insert 500 depicted in FIG. 14A placed within the inner diameter of the coil 110. The medical device 100 and the insert 500 are encapsulated (FIG. 14B), so that the insert 500 holds the coil 110 at a fixed internal diameter. Encapsulation is preferably performed at a low injection pressure of approximately 40 bar. The elastomeric insert 500 is unaffected by the moulding process and retains its shape and size even after curing of the encapsulation material.

The elastomeric insert 500 is sized to fill the void space 105 of the flexible coil 110 and not place any undue outward radial pressure onto the flexible coil 110. The encapsulation process may be considered complete at this stage. However, it is also possible for the then encapsulated medical device 100 to be further moulded to encapsulate, with elastomeric material, any portion of the flexible component not encapsulated during the first moulding process. Alternatively, the medical device may be partially encapsulated prior to the addition of the elastomeric insert. In this alternate embodiment, the partially encapsulated medical device and the elastomeric insert are moulded and thus encapsulated together to complete the encapsulation process.

In yet a further alternative embodiment, the mould die 900 depicted in FIG. 15 used for the encapsulation of the medical device 100 including a flexible coil 110, includes a thin annular (broken) ridge 600. The medical device 100 is moulded and thus encapsulated by an elastomeric material 200 depicted in FIG. 16 leaving only the volume defined by the mould dies 900 such as a moat 600′ (the negative volume in the moulded article of the ridge 600 in the die) unfilled by elastomeric material 200. The encapsulation of the medical device 100 is performed at a low injection pressure of approximately 40 bar to ensure that the medical device 100 including the flexible coil 110 is not distorted by undue moulding pressures since the shrinkage of the elastomeric material in at least a portion of the void region 105 is effectively uncoupled from the flexible coil by means of the formed annular moat 600′.

The encapsulated medical device 100 is then encapsulated for a second time by the elastomeric material 200 and heat cured such that the previously non-moulded areas such as the moat 600′ are filled in. This second encapsulation of the medical device is performed at a higher injection pressure than the first encapsulation process at a pressure of approximately 80 bar. The high pressure of the elastomeric material entering the volume of the moat 600′ forces the flexible coil 110 radially outwards and the previously moulded silicone in the void region 220 radially inwards then the curable elastomeric material shrinks as it cools to room temperature and displaced regions of the medical device 100 return to a desired preferred position.

In a second aspect of the invention, a medical device may have a flexible component made from a shape memory material such as but not limited to shape memory metals such as nitinol (NiTi) and nickel alloys.

The flexible component of shape memory material has a preferred memorised/first memorized shape and dimensions and has a void region within the flexible component. In one example, the room temperature shape of the flexible component may be formed into a coil. Before the medical device is to be encapsulated, the flexible component is physically expanded to have dimensions greater than its preferred memorised shape. The medical device with the flexible component in its expanded form is placed in a first mould with the mould adapted to fit the flexible component. The mould dies are shaped to enclose the dimensions of the medical device and at room temperature hold the expanded flexible component to restrict shrinking of the expanded flexible component. The mould may be shaped to extend into the void left inside the flexible coil that is to at least partially occupy the void.

The or at least part of the medical device is thus enclosed within the mould dies to create an enclosed environment and a single opening services the feed for insertion of liquefied elastomeric material. The medical device is thus at least partially encapsulated by the elastomeric material, in this case liquid silicone rubber and heat cured. Silicone therefore at least partially encapsulates the medical device including the flexible component. The void region of the flexible component may not be completely filled with the elastomeric material.

As the elastomeric material cures, the encapsulated flexible component shape memory material shrinks. The degree of shrinkage and the final memorised size of the coil are substantially proportional to the degree of shrinkage of the elastomeric material used to encapsulate the flexible component. Once the encapsulated flexible component reaches room temperature and the elastomeric material is fully cured, the encapsulated flexible component has substantially returned to its preferred/first memorised shape and dimensions. The encapsulated medical device may be further moulded.

Before loading the medical implant into either of the two moulds, the void region within the flexible component, may include an insert to hold the shape of the flexible component. The insert may be removed prior to encapsulation in the second mould or may be retained and encapsulated with the medical device as has been described previously.

In a third aspect of the invention, a medical device having a flexible component has within the flexible component void regions. The medical device is placed in a mould with the mould adapted to fit the flexible component. A mould die is shaped to extend into the void regions within the flexible component that is to at least partially occupy the void regions. The loaded medical device is thus enclosed within the mould to create an enclosed environment and a single opening services the feed for insertion of liquefied elastomeric material. The medical device including the flexible component is thus at least partially encapsulated by the elastomeric material, with the void regions not completely filled with the elastomeric material. As the elastomeric material cures and shrinks in volume, the flexible component may distort.

Formation of the flexible component into its preferred/first shape and dimensions occurs by inserting an insert of preformed material into the unoccupied volume of the void to expand the unoccupied volume by placing outward pressure on the cured elastomeric material encapsulating the flexible component. The void region remaining after encapsulation of the medical device may be designed to be undersized with respect to the object it is to accommodate even though, as the curable material cures the flexible components may adopt a distorted shape. Distortion of flexible components of the medical device occurs due to radial tension of the cured elastomeric material within the flexible components. To relive or counteract the resulting tension of the encapsulated flexible component, insertion of an object into the void region is undertaken providing the required relief or counteraction to bring the flexible component into conformance with its preferred shape, dimension and orientation. In one example, the void region may be designed to house a magnet. A magnet is a useful object because it can be useful for attracting the flexible component, such as a coil, into adjacency with externally located devices associated with the implanted medical device 100.

In yet a further alternative embodiment applicable to one or more of the encapsulation steps described the encapsulation processes may be performed within a specific range of temperatures operable in specific regions of the mould and or during curing periods. This is achieved by maintaining the elastomeric material injection nozzle in a single position. Depending on the curing rate of the elastomeric material, additional elastomeric material can be selectively injected. The path of elastomeric injection is not controlled.

The medical device and/or flexible component is placed in the mould dies and the temperature of the dies set to preferably enable the elastomeric material in some areas of the medical device to cure before others. Preferably the elastomeric material is delivered to the mould dies at a low injection pressure such as but not limited to 40 bar. Once the elastomeric material in the specific regions has cured, the injection pressure of the elastomeric material is increased to apply compressive forces to cured elastomeric material.

In one embodiment, the portion of the mould adjacent the flexible component may be at a substantially higher temperature than some or all of the portions of the mould not adjacent the flexible component. In such an embodiment, the temperature is set such that the elastomeric material adjacent the flexible component cures before the elastomeric material located within any void regions within of the flexible component. The void region is kept at a low temperature to delay elastomeric material curing. Once the elastomeric material adjacent the flexible component cures the injection pressure of the elastomeric material is increased. This preferably results in radial compressive forces applied to the cured elastomeric material in the outer areas of the flexible component. As the elastomeric material delivered at the higher pressure cures in the void region of the flexible component, the flexible component shrinks upon cooling. This relaxes the compressive stresses developed adjacent to the flexible component and thus prevents any unnecessary distortion of the encapsulated medical device and or flexible component/s. The encapsulated medical device and or flexible component/s may then be further moulded.

Although an embodiment of the method and system of the present invention has been described in the foregoing detailed description, it will be understood that the invention is not limited to the embodiment disclosed, but is capable of numerous rearrangements, modifications and substitutions without departing from the scope of the invention as set forth and defined by the following claims.

1. A method of encapsulation of a flexible component, the flexible component having, prior to encapsulation, a first shape and first dimensions including a void within the flexible component, the method including:
at least partially encapsulating the flexible component in a first mould which partially occupies the void, using a curable material which shrinks in volume as it cures, wherein the void is partially occupied by cured material and the flexible component is distorted from a shape prior to the partial encapsulation after the encapsulating material has cured; and
at least partially encapsulating the flexible component in a second mould using a curable material at a pressure so as to at least fill and expand an unoccupied volume of the void such that the flexible component substantially conforms to the first shape and first dimensions of the flexible component.

2. The method of encapsulation as claimed in claim 1, further comprising:
placing an insert of preformed material compatible with the curable material within the void before the flexible component is placed in the first mould.

3. The method of encapsulation as claimed in claim 2, wherein the insert of preformed material is removed and the flexible component is returned to the first mould using curable material to fill the unoccupied volume previously filled by the insert.

4. The method of encapsulation as claimed in claim 2, further comprising:
removing the insert of preformed material from the void before the flexible component is placed in the second mould.

5. The method of encapsulation of a flexible component as claimed in claim 1, further comprising:
placing an insert of preformed material compatible with the curable material within the void before the flexible component is placed in the second mould.

6. A method of encapsulation of a flexible component of shape memory material, the flexible component having, prior to encapsulation, a memorized shape and memorized dimensions including a void within the flexible component, the method including:
placing the flexible component in an expanded shape in a first mould which partially occupies the void; and
at least partially encapsulating the flexible component in the first mould, using a curable material which shrinks in volume as it cures, wherein the void is partially occupied by cured material and the memorized shape and memorized dimensions of the flexible component are substantially restored once the encapsulating material has cured.

7. The method of encapsulation as claimed in claim 6, further comprising:
placing the at least partially encapsulated flexible component in a second mould and further encapsulating the partially encapsulated flexible component using a curable material at a pressure without, once cured cured, substantially distorting the encapsulated flexible component.

8. The method of encapsulation as claimed in claim 6, further comprising:
placing an insert of preformed material compatible with the curable material within the void before the flexible component is placed in the first mould.

9. The method of encapsulation as claimed in claim 8, wherein the insert of preformed material is removed the void before the flexible component is placed in the second mould.

10. The method of encapsulation of a flexible component as claimed in claim 7, further comprising:
placing an insert of preformed material compatible with the curable material within the void before the flexible component is placed in the second mould.

11. The method of encapsulation as claimed in claim 1, wherein the portion of the first mould adjacent to the flexible component is at a substantially higher temperature than some or all of the portions of the mould not adjacent to the flexible component during curing of the curable material so as to shorten the curing period in the encapsulated volume adjacent the flexible component relative to that which would occur if the portion of the first mould adjacent to the flexible component is not at a substantially higher temperature than some or all of the portions of the mould not adjacent to the flexible component during curing of the curable material.

12. The method of encapsulation as claimed in claim 1, further comprising:
injecting the curable material into the second mould at an injection pressure higher than that used for the first mould to compress cured curable material.

13. The method of encapsulation as claimed in claim 1, wherein the flexible component is part of or coupled to a medical device and wherein both the flexible component and medical device are encapsulated by the curable material in a respective mould.

14. The method of encapsulation as claimed in claim 1, wherein the second mould is adapted to provide at least one further void adjacent to the flexible component not within the void within the flexible component, the method further comprising:
filling the at least one further void with a curable material such that the associated cured material creates an expansion pressure on the partially encapsulated flexible component when the flexible component is placed in the second mould.

15. A method of encapsulation of a flexible component, the flexible component having, prior to encapsulation, a first shape and first dimensions including a void within the flexible component, the method including:
at least partially encapsulating the flexible component in a first mould which partially occupies the void, using a curable material which shrinks in volume as it cures, wherein the void is partially occupied by cured material and the flexible component is distorted from a shape prior to the partial encapsulation after the encapsulating material has cured;
wherein the method further includes using an insert of preformed material compatible with the curable material so as to at least fill and expand unoccupied volume of the void such that the flexible component substantially conforms to the first shape and first dimensions of the flexible component.

16. The method of encapsulation as claimed in claim 13, the method further comprising:
further encapsulating the at least partially encapsulated flexible component is so as to at least encapsulate the insert.

17. The method of encapsulation as claimed in claim 1, wherein the flexible component is or is part of a medical device.

18. (canceled)

19. (canceled)

20. (canceled)

21. (canceled)

22. The method of claim 1, wherein the flexible component is a flexible antenna coil connected to a stimulator housing of a cochlear implant system.

23. The method of claim 6, wherein the flexible component is a flexible antenna coil connected to a stimulator housing of a cochlear implant system.

24. The method of claim 12, wherein the flexible component is a flexible antenna coil connected to a stimulator housing of a cochlear implant system.
